(19) United States
(12) Patent Application Publication
(10) Pub. No.: US 2009/0139623 A1
(43) Pub. Date: Jun. 4, 2009

(54) PNEUMATIC VEHICLE TIRE WITH RUNFLAT CHARACTERISTICS

(75) Inventor: Silvia Kaiser, Hannover (DE)

Correspondence Address: LERNER GREENBERG STEMER LLP, P O BOX 2480, HOLLYWOOD, FL, 33022-2480, US

(73) Assignee: CONTINENTAL AKTIENGESELLSCHAFT, Hannover (DE)

(21) Appl. No.: 12/326,449

(22) Filed: Dec. 2, 2008

Related U.S. Application Data
(63) Continuation of application No. PCT/EP2007/053601, filed on Apr. 13, 2007.

(30) Foreign Application Priority Data
Jun. 2, 2006 (DE) DE 102006025794.4

(51) Int. Cl. B60C 17/04

(52) U.S. Cl. 152/517

(57) ABSTRACT

A vehicle pneumatic tire with run-flat characteristics is formed of a profiled tread, multilayered belting, an air-tight inner layer, a carcass wound around high-tensile strength cores and core profiles on cores in the bead area, axially from inside to outside as a carcass riser, side walls within which there is at least one reinforcing profile with a crescent-shaped cross section closed annularly over the circumference of the side wall, and a bead reinforcing element with a reinforcement. The bead reinforcing element that is axially inside of the core profile has reinforcements oriented at a 90 degree angle to the tread periphery, and the carcass is configured as a single layer.

### CROSS-REFERENCE TO RELATED APPLICATION

This is a continuing application, under 35 U.S.C. § 120, of copending international application No. PCT/EP2007/053601, filed Apr. 13, 2007, which designated the United States; this application also claims the priority, under 35 U.S.C. § 119, of German patent application No. DE 10 2006 025 794.4, filed Jun. 2, 2006; the prior applications are herewith incorporated by reference in their entirety.

### BACKGROUND OF THE INVENTION

### Field of the Invention

The invention relates to a pneumatic vehicle tire with runflat characteristics, containing a profiled tread rubber, a multiply breaker belt assembly, an airtight inner layer, a carcass, which is wound around high-tensile strength cores and bead fillers on the cores in the bead region, axially from inside to outside as a carcass turn-up, sidewalls, within which there is at least one reinforcing profile with a crescent-shaped cross section closed annularly over the circumference of the sidewall, and a bead reinforcing element with strengthening supports.

Such self-supporting pneumatic vehicle tires, which keep running in the event of puncture, are sufficiently known in various forms. The reinforcing profiles introduced in the region of the sidewalls of the tire are formed with respect to their cross-sectional shape and their elastomer mixtures in such a way that they are capable of making the tire self-supporting when there is a loss of compressed air in the event of puncture, so that it is made possible to keep running over a certain distance. In the event of a loss of compressed air, the self-supporting capability of the runflat tire is achieved by the insert (reinforcing profile) that is arranged in the tire sidewall being subjected to compressive loading, while the carcass lying against the insert is subjected to tensile loading. This interaction of the carcass and the insert enable the tire to keep running and the bead profile to remain seated on the rim. However, the forces acting on the insert as a result of the deflection of the tire, in particular on account of the deflection in the region of the tread contact area, are enormously high. In the case of known runflat tires, it is therefore problematic to keep the tire running when flat over a relatively long distance. This is so since the insert material becomes fatigued when the tire runs flat over a certain distance and ruptures. In order to prevent premature loss of the runflat capability, two-ply carcass constructions and strongly designed inserts are used in the case of runflat tires. Although these measures increase the distance that can be covered in the event of puncture, the running characteristics in normal operation deteriorate as a result of stiffening of the tire sidewalls and, what is more, tire manufacture becomes more expensive as a result of increased use of material and a more complex tire construction.

A self-supporting tire of the type mentioned at the beginning is disclosed for example by U.S. Pat. No. 6,401,777 B1. The tire is made able to keep running in the event of puncture by two axially adjacent, cross-sectionally crescent-shaped inserts and two carcass plies in the region of its sidewalls. In the region of the bead, the tire has a bead reinforcing element known as a “chipper”. The bead reinforcing element is arranged axially outside the bead filler between this bead filler and the carcass turn-up and has strengthening supports, which are arranged at an angle of 30° to 50° in relation to the circumferential surface of the tread rubber. The bead reinforcing element, with its strengthening supports arranged at an angle of 30° to 50° in relation to the circumferential surface, is intended inter alia to serve in the event of puncture for protecting the bead profile from cracking, known as the “chafer region”, and consequently for preventing premature failure of the tire should it become punctured, due to inadequate seating on the rim. It is disadvantageous, however, that the tire is likewise stiffened in normal operation by the use of a two-ply carcass, two inserts and the bead reinforcing element described above, which has adverse effects on the running and comfort-related characteristics and is expensive to manufacture.

### SUMMARY OF THE INVENTION

It is accordingly an object of the invention to provide a pneumatic vehicle tire with runflat characteristics that overcome the above-mentioned disadvantages of the prior art devices of this general type, which has good running and comfort-related characteristics in normal operation, but can keep running flat over a long distance. The tire is to be simple and inexpensive to manufacture in comparison with runflat tires of the generic type.

With the foregoing and other objects in view there is provided, in accordance with the invention, a pneumatic vehicle tire with runflat characteristics. The tire includes a profiled tread rubber, a multiply breaker belt assembly, an airtight inner layer, high-tensile strength cores, bead fillers disposed on the high-tensile strength cores in a bead region, a carcass being of a single-ply configuration and wound around the high-tensile strength cores and the bead fillers, axially from inside to outside and having a carcass turn-up, a sidewall, at least one reinforcing profile with a crescent-shaped cross section closed annularly over a circumference of the sidewall and within the sidewall, and a bead reinforcing element having strengthening supports. The bead reinforcing element is disposed axially inside the bead fillers. The strengthening supports of the bead reinforcing element are aligned at an angle of 90° in relation to a circumferential surface of the profiled tread rubber.

The object is achieved by the bead reinforcing element being arranged axially inside the bead filler, by the bead reinforcing element having strengthening supports which are aligned at an angle of 90° in relation to the circumferential surface of the tread rubber and by the carcass being of a single-ply configuration.

Important for the invention is the combination of the ply containing the bead reinforcing element, namely axially inside the bead filler, the special arrangement of the strengthening supports of the bead reinforcing element, namely at an angle of approximately 90° in relation to the circumferential surface of the tread rubber, and the carcass of a single-ply configuration.

The surprising effect of the invention is that the carcass is reinforced in the bead region by a ply containing strengthening supports (bead reinforcing element), lying axially inside the bead filler. By locally reinforcing the carcass in the bead region, this arrangement brings about a stiffening of the tread contact area, while the remaining sidewall region is not reinforced. The reinforcement has the effect that the deflection in the region of the tread contact area is reduced should the tire become punctured, while the desired characteristics of a single-ply carcass construction are retained.

The way in which the runflat tire is formed according to the invention achieves running behavior and running comfort in normal operation with normal air pressure that to a great extent approximate a tire without runflat characteristics. The carcass of a single-ply configuration that can then be structurally realized by the use of the bead reinforcing element makes good handling behavior possible and has improved deflection behavior in comparison with runflat tires with a two-ply carcass construction disclosed by the prior art, as a result of reduced stiffening in the region of the sidewall and the shoulder. In normal operation, the arrangement of the bead reinforcing element causes no circumferential stiffening. The tire is less expensive to manufacture than known runflat tires on account of lower material consumption and only few working steps. Nevertheless, the runflat characteristic, in particular the distance covered in the event of puncture, is prolonged by relieving the load on the insert. The bead reinforcing element arranged axially inside the bead filler, with the strengthening supports of this element extending at an angle of approximately 90° in relation to the circumferential surface (radially), that is to say arranged parallel to the loading while running flat, has the effect that, when the tire is running flat, the tensile forces of the filaments of the strengthening supports are optimally exploited, whereby the deflection of the tire in the region of the tread contact area is reduced. The loading of the insert is consequently reduced in spite of an only single-ply carcass construction, and the service life of the insert while running flat is prolonged. A longer distance can be covered when running flat.

The arrangement of the strengthening supports in the bead reinforcing element of approximately 90° in relation to the circumferential surface may deviate by about 10° from the radial alignment, the desired effect of reducing the deflection of the tire in the region of the tread contact area while running flat to obtain a longer service life of the insert being achievable nevertheless by exploitation of the tensile force of the filaments.

It is advantageous if a single, cross-sectionally crescent-shaped reinforcing profile is arranged in the sidewall. The use of the bead reinforcing element according to the invention in combination with the carcass of a single-ply configuration also makes it possible to design the reinforcing profile to be thinner than previously customary, and consequently further reduce the stiffening of the sidewall. In a preferred embodiment, the reinforcing profile may have an axial width of 6 to 15 mm.

The strengthening supports of the bead reinforcing element are preferably formed as fabric cords, which preferably consist of rayon, polyester, nylon or steel. These are tension-resistant materials, which moreover are expensive to manufacture and process in tire building.

The bead reinforcing element has a cross-sectional height of 20 mm to 60 mm (measured in the curved length), preferably 35 mm, in order to keep the tire running flat in the event of puncture over as long a distance as possible but not adversely influence the running and comfort-related characteristics in normal operation. It should be noted that the aforementioned cross-sectional height is dependent on the tire dimension.

The radially inward end of the bead reinforcing element is arranged in the region of the cross-sectional height of the rim horn, in particular in the region of the cross-sectional height of the bead core or a few mm above the bead core. The radially outer end ends outside the cross-sectional height of the rim horn. This may be a few mm above the rim horn, or up to half the cross-sectional height of the tire.

The bead reinforcing element is located within the cross-sectional height of the carcass turn-up, unless the turned-back portion of the ply ends below the bead filler.

In one particular embodiment, the bead reinforcing element is arranged between the carcass and the axially inner side of the bead filler in the region of the bead.

In another embodiment, the bead reinforcing element is arranged axially inside the carcass, with its axially outer surface lying directly against the carcass. In this arrangement, the strengthening supports of the bead reinforcing element are exposed to higher tensile forces in the event of a loss of compressed air than in the case of an arrangement between the axially inner side of the bead filler and the carcass, and can relieve the insert of load very considerably by reducing the deflection of the tire in the region of the tread contact area.

In the case of the last-mentioned embodiment, it is advantageous if the radially inner end of the bead reinforcing element is arranged alongside and within the cross-sectional height of the bead core. As a result, improved stiffening is obtained in the event of puncture. However, complete or partial wrapping of the bead reinforcing element around the core, axially from inside to outside, is to be avoided. The bead reinforcing element wrapped completely or partially around the core brings difficulties in the tire building process. In the finished ready-to-use tire, such an arrangement has adverse effects on the uniformity of the tire.

In an advantageous embodiment, the radially outer end of the bead reinforcing element may be arranged within the cross-sectional height of the turned-back portion of the carcass that is turned back onto the carcass.

In the case of the aforementioned embodiments, instead of a single-ply carcass, in the case of which the carcass turn-up is turned back onto the carcass and ends in the region of the sidewall (1+0-ply construction), it is also possible to use an arrangement of a single-ply carcass with a carcass turn-up reaching under the breaker belt (C-ply construction).

Other features which are considered as characteristic for the invention are set forth in the appended claims.

Although the invention is illustrated and described herein as embodied in a pneumatic vehicle tire with runflat characteristics, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, partial cross-sectional view through an SSR radial-ply tire for passenger cars according to the invention;

FIG. 2 is a diagrammatic, side view of a configuration o the strengthening supports of the bead reinforcing element; and

FIG. 3 is a diagrammatic, partial cross-sectional view through an SSR radial-ply tire for passenger cars.

### DETAILED DESCRIPTION OF THE INVENTION

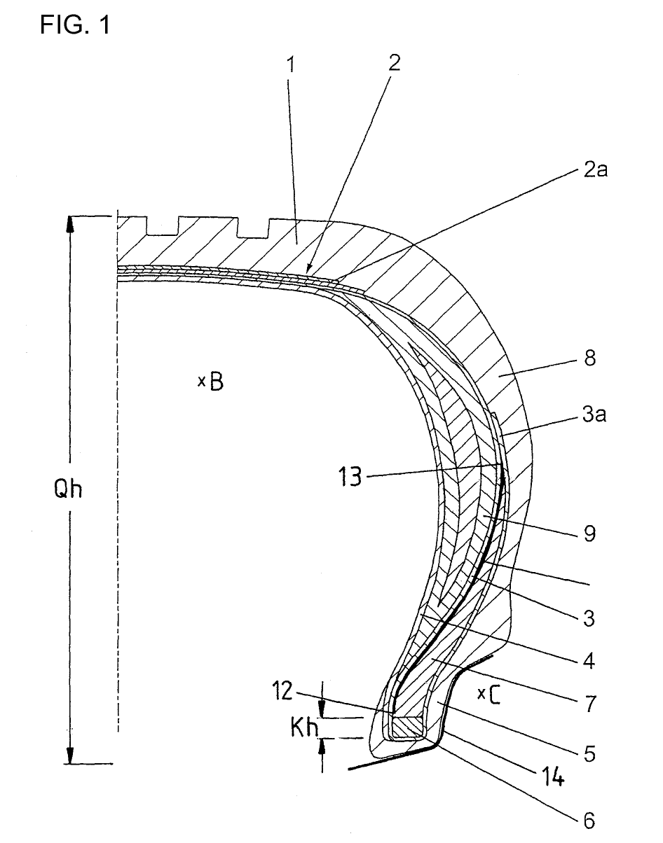

Referring now to the figures of the drawing in detail and first, particularly, to FIG. 1 thereof, there is shown in a partial cross-sectional view an SSR radial-ply tire for passenger cars. The main component parts making up the radial-ply tire represented are: a profiled tread rubber 1, a breaker belt 2 having two plies 2a in the embodiment shown, a carcass 3, in particular of a single-ply configuration, an inner layer 4, of a largely airtight configuration, beads 5 with bead cores 6 and bead fillers 7, as well as sidewalls 8 and approximately crescent-shaped reinforcing profiles 9. The reinforcing profile 9, as represented in the figures, is formed of two different materials: an inner profile and an outer profile, which encloses the inner profile. According to the invention, however, the reinforcing profile may also be formed of only one material. “SSR” stands for “Self Support Runflat Tire” and refers to pneumatic vehicle tires with runflat characteristics on the basis of reinforced sidewalls. The two plies 2a of the breaker belt 2 contain strengthening supports of steel cord that are embedded in a rubber mixture and run parallel to one another within each ply, steel cords of one ply 2a being oriented in a crossing arrangement in relation to the steel cords of the second ply 2a and respectively forming an included angle of between 20° and 35° with the circumferential direction of the tire. The carcass 3 may also be configured in a conventional and known way, and consequently have reinforcing filaments of a textile material or of steel cord embedded in a rubber mixture and running in a radial direction. The carcass 3 is led around the bead cores 6 from the inside to the outside; their turn-ups 3a run alongside the bead fillers 7 in the direction of the breaker belt 2.

The reinforcing profile 9, produced from elastomeric material, in particular from a rubber mixture, has been positioned on the inner layer 4 during the building of the tire and is therefore located between the inner layer and the carcass 3. The thickness of the reinforcing profile 9 decreases both in the direction of the breaker belt 2 and in the direction of the bead 5. In the direction of the breaker belt 2, the reinforcing profile 9 reaches under the edge regions. In the direction of the bead 5, the reinforcing profile 9 ends just above the bead core 6. Over most of the length of the sidewall, the reinforcing profile 9 is made virtually constantly thick; its thickness is 6 to 15 mm.

Arranged axially inside the bead filler 7, between the latter and the carcass 3, is a bead reinforcing element 10, closed annularly over the circumference of the sidewall. The bead reinforcing element 10 has radially arranged textile strengthening supports 11 in the form of cords that are spaced approximately uniformly from one another and are embedded in a rubber mixture and is a reinforcing ply in the form of a ribbon in the bead region 5 of the tire. The radially inner end 12 of the bead reinforcing element begins in the bead region at a cross-sectional height that lies within the cross-sectional height of the rim horn 14, here 1 mm above the bead core 6, and reaches inside the carcass turn-up 3a with its radially outer end 13 almost up to half the cross-sectional height Qh of the radial-ply tire.

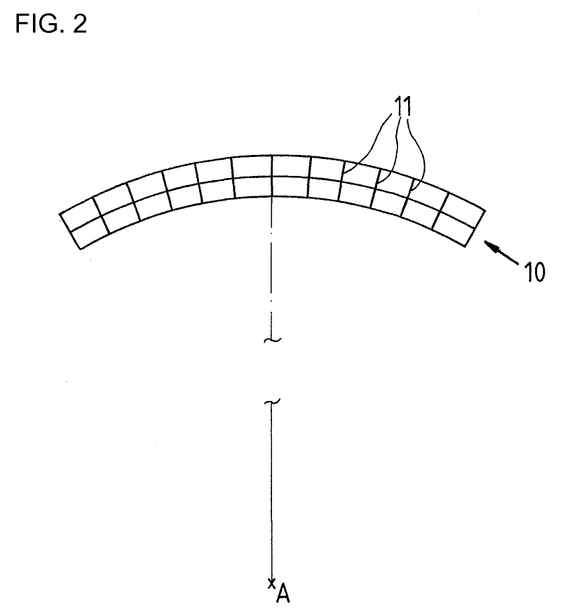

When running flat in the event of puncture with a loss of compressive air, the shoulder region is (in simple terms) subjected to loading about an arc around the point B and the bead region 5 is subjected to loading about an arc around the point C. The single-ply carcass 3 is locally reinforced by the strengthening support ply 10 of the bead reinforcing element arranged axially inside the bead filler 7. As FIG. 2 shows in side view of the strengthening supports 11, the strengthening supports 11 run in radial alignment to the center point A, equivalent to an angle of 90° in relation to the circumferential surface. So, when the tire is subjected to loading while running flat, the radially running forces are optimally subjected by the strengthening supports 11, likewise arranged radially inside the bead reinforcing element, to their tensile force, so that the deflection in the region of the tread contact area is reduced. Only stiffening of the tread contact area takes place, as a result of which the reinforcing profile 9 is not subjected to such great loading. When running flat, the tensile forces of the strengthening supports are optimally exploited as a result of their parallel arrangement in relation to the forces occurring while running flat and on account of the smallest possible length of the strengthening supports, whereby the deflection of the tire in the region of the tread contact area is reduced. By locally reinforcing the carcass 3 in the bead region 5, this arrangement according to the invention brings about a stiffening of the tread contact area, while the remaining sidewall region 8 is not stiffened. The reinforcement has the effect that the deflection in the region of the tread contact area while running flat is reduced, while the other positive characteristics of a single-ply carcass construction are retained. This achieves running behavior and running comfort in normal operation with normal air pressure that to a great extent approximate a tire without runflat characteristics. The carcass 3, 3a of an only single-ply configuration makes good handling behavior possible and has improved deflection behavior in comparison with a two-ply carcass, as a result of reduced stiffening. When running flat, the distance covered by the self-supporting tire is prolonged by relieving the load on the reinforcing profile 9. The loading of the reinforcing profile is consequently reduced in spite of an only single-ply carcass construction 3, 3a, and the service life of the reinforcing profile 9 while running flat is prolonged.

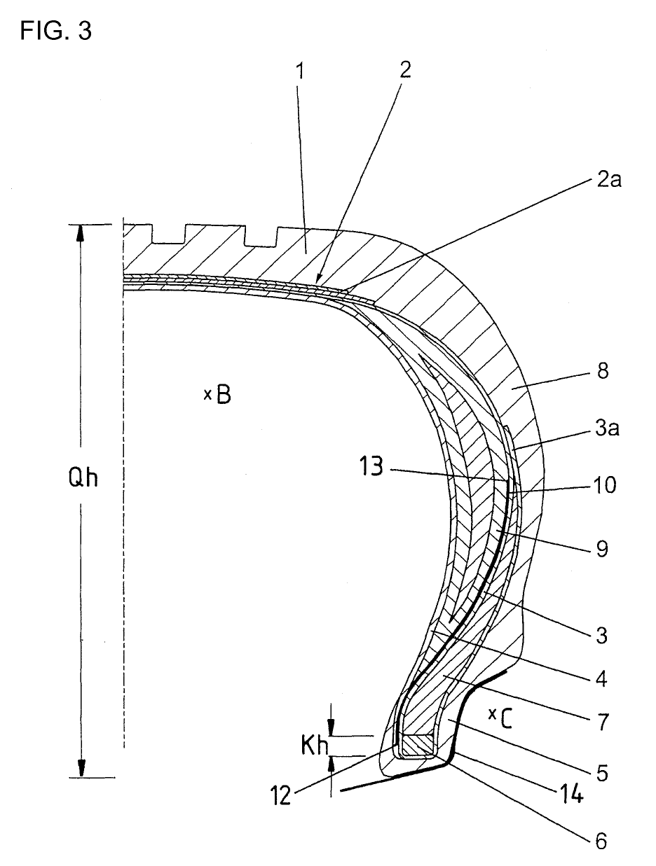

In FIG. 3, a partial cross section through the radial ply tire for passenger cars described in FIG. 1 and FIG. 2 is represented, with a different arrangement of the bead reinforcing element 10 described above. In the radially inner half of the cross section, the bead reinforcing element 10 is arranged axially inside the carcass 3, directly following the course of the carcass 3. The radially inner end 12 of the bead reinforcing element 10 begins at half the cross-sectional height of the bead core Kh, and in this region is arranged between the inner layer 4 and the carcass 3. If the arrangement of the bead reinforcing element 10 is followed in the radially outer direction, the fact that the bead reinforcing element is directly adjacent to the carcass with its axially outer side within its entire radial course means that, as from the cross-sectional height Qh in which the reinforcing profile 9 begins, the bead reinforcing element is enclosed between this reinforcing profile 9 and the carcass 3. The radially outer end 13 of the bead reinforcing element 10 ends at a cross-sectional height that lies within the turned-back portion 3a of the carcass.

1. A pneumatic vehicle tire with runflat characteristics, comprising:
a profiled tread rubber;
a multiply breaker belt assembly;
an airtight inner layer;
high-tensile strength cores;
bead fillers disposed on said high-tensile strength cores in a bead region;
a carcass being of a single-ply configuration and wound around said high-tensile strength cores and said bead fillers, axially from inside to outside and having a carcass turn-up;
a sidewall;
at least one reinforcing profile with a crescent-shaped cross section closed annularly over a circumference of said sidewall and within said sidewall; and
a bead reinforcing element having strengthening supports, said bead reinforcing element disposed axially inside said bead fillers, said strengthening supports of said bead reinforcing element being aligned at an angle of 90° in relation to a circumferential surface of said profiled tread rubber.

2. The pneumatic vehicle tire according to claim 1, wherein said strengthening supports of said bead reinforcing element are fabric cords.

3. The pneumatic vehicle tire according to claim 1, wherein said bead reinforcing element has a height of 20 mm to 60 mm.

4. The pneumatic vehicle tire according to claim 1, wherein:
said carcass has an axially inner side; and
said bead reinforcing element is disposed between said carcass and said axially inner side of said bead fillers.

5. The pneumatic vehicle tire according to claim 1, wherein said bead reinforcing element is disposed axially inside said carcass.

6. The pneumatic vehicle tire according to claim 5, wherein said bead reinforcing element has a radially inner end disposed within a cross-sectional height of said bead core.

7. The pneumatic vehicle tire according to claim 1, wherein:
said carcass has a turned-back portion being turned back onto said carcass; and
said bead reinforcing element has a radially outer end disposed within said turned-back portion of said carcass that is turned back onto said carcass.

8. The pneumatic vehicle tire according to claim 2, wherein said fabric cords have a material selected from the group consisting of rayon, polyester, nylon and steel.

9. The pneumatic vehicle tire according to claim 3, wherein said height is 35 mm.
